(19) United States
(12) Patent Application Publication
(10) Pub. No.: US 2019/0078502 A1
(43) Pub. Date: Mar. 14, 2019

(54) MULTI-TURBOCHARGER SYSTEMS AND METHODS OF OPERATING SAME

(71) Applicant: HYPERCAR DEVELOPMENT LLC, Cornelius, NC (US)

(72) Inventor: Safa YOUSEF, Charlotte, NC (US)

(21) Appl. No.: 15/767,986

(22) PCT Filed: Sep. 1, 2017
(86) PCT No.: PCT/US17/49794

§ 371 Date: Apr. 12, 2018

Related U.S. Application Data
(63) Continuation-in-part of application No. PCT/US2017/018816, filed on Feb. 22, 2017.

(51) Int. Cl. F02B 37/00; F02B 37/007; F02D 41/00; F02B 37/18; F02B 3/06

(52) U.S. Cl. CPC F02B 37/001; F02B 37/007; F02D 41/0007; F05D 2220/40; F02B 3/06; F02D 2041/001; F02D 2200/0406; F02B 37/186

(57) ABSTRACT

One embodiment relates to a system including first, second, and third turbochargers. The first and second turbocharger include respective first and second turbines in fluid receiving communication with an exhaust manifold of an engine, and respective first and second compressors in fluid providing communication with an intake manifold of the engine. The third turbocharger includes a third turbine in fluid receiving communication with each of the first and second turbines, and a third compressor in fluid providing communication with each of the first and second compressors. A first control valve is controllable so as to controllably permit flow between the first and third compressors. A second control valve is controllable so as to controllably permit flow between the second and third compressors.

### CROSS-REFERENCE TO RELATED PATENT APPLICATIONS

U.S. Provisional Patent Application 62/298,960, filed Feb. 23, 2016, including the specification, drawings, claims and abstract, is incorporated herein by reference in its entirety. This application is a Continuation-In-Part of PCT Application No. PCT/US2017/018816, filed Feb. 22, 2017, incorporated herein by reference in its entirety.

### TECHNICAL FIELD

The present disclosure relates generally to multi-turbocharger systems and methods for operating the same. More particularly, various embodiments relate to turbocharger systems having three turbochargers, and methods of operating the same.

### BACKGROUND

Turbochargers increase the mass air flow for a given engine displacement and given engine speed, thereby increasing the power density. Exhaust gas turbochargers operate using power extracted from hot exhaust gas produced by an engine.

A conventional exhaust gas turbocharger includes a compressor and a turbine connected to each other by a common shaft. The compressor is fluidly coupled to an intake manifold of the engine and the turbine is fluidly coupled to an exhaust manifold of the engine. The turbine converts some of the energy contained in the hot exhaust gas into mechanical work to drive the compressor. The compressor compresses intake air before it enters the intake manifold. This improves the engine's volumetric efficiency by increasing the density of the charge air, thereby enabling more power to be produced per engine cycle.

### SUMMARY

One embodiment relates to a system including first, second, and third turbochargers. The first turbocharger includes a first turbine in fluid receiving communication with an exhaust manifold of an engine, and a first compressor in fluid providing communication with an intake manifold of the engine. The second turbocharger includes a second turbine in fluid receiving communication with the exhaust manifold, and a second compressor in fluid providing communication with the intake manifold. The third turbocharger includes a third turbine in fluid receiving communication with each of the first and second turbines, and a third compressor in fluid providing communication with each of the first and second compressors. A first control valve is positioned in a first intake conduit fluidly coupling the first and third compressors. The first control valve is controllable between a first position enabling flow between the first and third compressors, and a second position blocking flow between the first and third compressors and enabling flow from external atmosphere to the first compressor. A second control valve is positioned in a second intake conduit fluidly coupling the second and third compressors. The second control valve is controllable between a first position enabling flow between the second and third compressors, and a second position blocking flow between the second and third compressors and enabling flow from external atmosphere to the second compressor.

One other embodiment relates to a variable velocity turbocharger. The variable velocity turbocharger includes a turbine structured to be fluidly coupled to an exhaust manifold of an engine. The variable velocity turbocharger also includes a compressor structured to be fluidly coupled to an intake manifold of the engine. The variable velocity turbocharger further includes a variable velocity turbocharger differential structured to control a first rotational velocity of the turbine relative to a second rotational velocity of the compressor.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a schematic diagram of a multi-turbocharger system, according to an embodiment.

FIG. 2 is a schematic diagram of a multi-turbocharger system, according to another embodiment.

FIG. 3A is a schematic diagram of a variable velocity turbocharger, according to an embodiment.

FIG. 3B is a schematic diagram of the variable velocity turbocharger of FIG. 3A, according to an embodiment.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

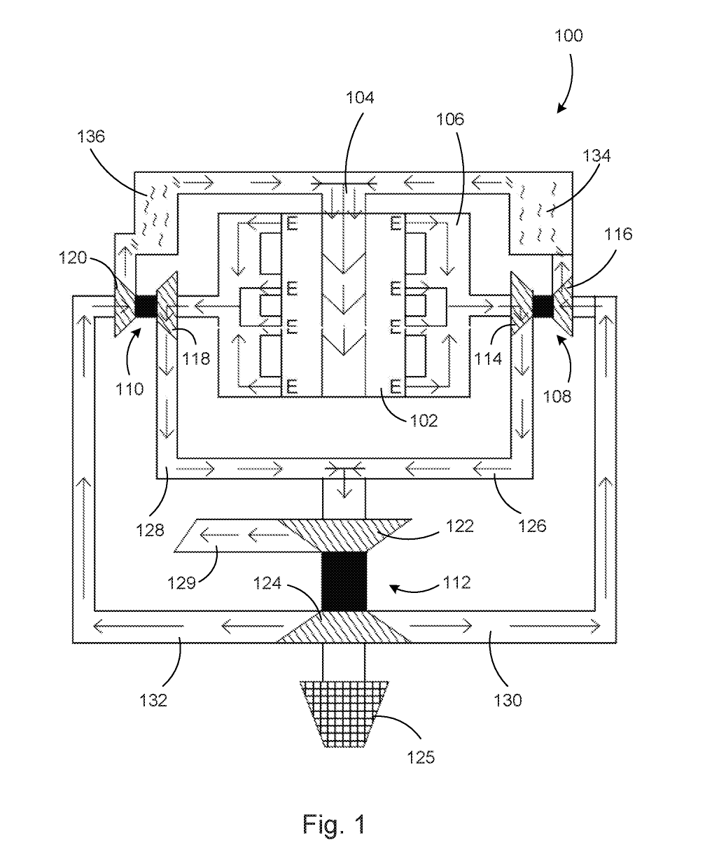

FIG. 1 is a schematic diagram of a multi-turbocharger system 100, according to an embodiment. In general, the turbocharger system 100 is structured to increase the amount of power produced by an engine 102 by converting enthalpy in exhaust gas produced by the engine 102 into mechanical energy to compress intake air provided to the engine 102. The engine 102 includes an intake manifold 104 and an exhaust manifold 106. In some embodiments, the engine 102 is a high-power, high-RPM, and low-displacement engine, such as in a high-performance vehicle.

The turbocharger system 100 includes a first turbocharger 108, a second turbocharger 110, and a third turbocharger 112. The first turbocharger 108 includes a first turbine 114 and a first compressor 116. The first turbine 114 is in fluid (e.g., exhaust gas) receiving communication with the exhaust manifold 106. The first compressor 116 is in fluid (e.g., intake air) providing communication with the intake manifold 104.

The second turbocharger 110 includes a second turbine 118 and a second compressor 120. The second turbine 118 is in fluid (e.g., exhaust gas) receiving communication with the exhaust manifold 106. The second compressor 120 is in fluid (e.g., exhaust gas) providing communication with the intake manifold 104.

The third turbocharger 112 includes a third turbine 122 in fluid (e.g., exhaust gas) receiving communication with each of the first and second turbines 114, 118, and a third compressor 124 in fluid (e.g., intake air) providing communication with each of the first and second compressors 116, 120. A clean air intake 125 is operatively coupled to the third compressor 124. In some embodiments, the clean air intake 125 includes an air filter.

The turbocharger system 100 also includes various conduits for fluidly coupling the components. More specifically, a first exhaust conduit 126 fluidly couples the first turbine 114 and the third turbine 122. A second exhaust conduit 128 fluidly couples the second turbine 118 and the third turbine 122. The first and second exhaust conduits 126, 128 join to form a common passage coupled to the third turbine 122. A third exhaust conduit 129 fluidly couples the third turbine 122 and external atmosphere. A first intake conduit 130 fluidly couples the third compressor 124 and the first compressor 116. A second intake conduit 132 fluidly couples the third compressor 124 and the second compressor 120.

The first and second turbochargers 108, 110 are configured in a closed circuit relative to the third turbocharger 112. Accordingly, the first and second turbochargers 108, 110 enhance operation of the third turbocharger 112 and vice versa. For example, during start-up, exhaust gas from the engine 102 spins the first and second turbines 114, 118, which in turn spin the first and second compressors 116, 120. This effectively creates a vacuum in the first and second intake conduits 130, 132, which causes the third turbocharger 112 to begin to spool more quickly than in conventional turbocharger systems. This can be referred to as “scavenging” for boost.

The turbocharger system 100 also includes a first intercooler 134 downstream of the first compressor 116 and upstream of the intake manifold 104, and a second intercooler 136 positioned downstream of the second compressor 120 and upstream of the intake manifold 104. The first and second intercoolers 134, 136 are structured to cool the intake air to further increase the charge density.

In general, the first and second turbochargers 108, 110 are high-pressure turbochargers, and the third turbocharger 112 is a low-pressure, high flow rate turbocharger. The first and second turbochargers 108, 110 are smaller than the third turbocharger 112 and, therefore, are structured to spool up quicker than the third turbocharger 112. More specifically, the impellers and shafts of the first and second turbochargers 108, 110 are smaller than those of the third turbocharger 112. Accordingly, the lower mass moment of inertia of the smaller first and second turbochargers 108, 110 improves the transient response of the turbocharger system 100.

The size and configuration of the first, second, and third turbochargers 108, 110, 112 are optimized to provide high-boost and fast transient response at all operating speeds of the engine. In operation, the first and second turbochargers 110 are structured to operate at or above 120,000 RPM at full boost. The first and second turbochargers 108, 110 are structured to withstand the higher volumetric flow rate produced by the third turbocharger 112 without either of the first and second turbochargers 108, 110 choking (e.g., due to volumetric flow rate differential), and/or generating unfavorable backpressure.

In some embodiments, the third turbocharger 112 is structured to generate boost levels of at least 20 PSI. The configuration of the triple turbocharger system 100 also allows for higher volumetric flow rates than conventional turbocharger systems by distributing the load into a set of twin turbochargers, namely, the first and second turbochargers 108, 110. The first and second turbochargers 108, 110 are able to handle higher intake loads because the total volumetric flow rate of the intake air from the third turbocharger 112 is distributed equally between the first and second turbochargers 108, 110. Additionally, the turbocharger system 100 exhibits reduced lag because the combined exhaust gas from both of the first and second turbochargers 108, 110 is forced to the third turbine 122, thereby causing the third turbocharger 112 to spool up more quickly than in conventional turbocharger systems.

The turbocharger system 100 provides the benefits of both parallel and sequential twin-turbocharger systems. For example, the first and second turbochargers 108, 110 operate as a parallel turbocharger system, which exhibits rapid transient build-up of boost pressure. Each combination of the first and third turbochargers 108, 112, and the second and third turbochargers 110, 112 operate as sequential twin turbocharging systems, in which intake air is pre-compressed by the third turbocharger 112 and is further compressed by each of the first and second turbochargers 108, 110.

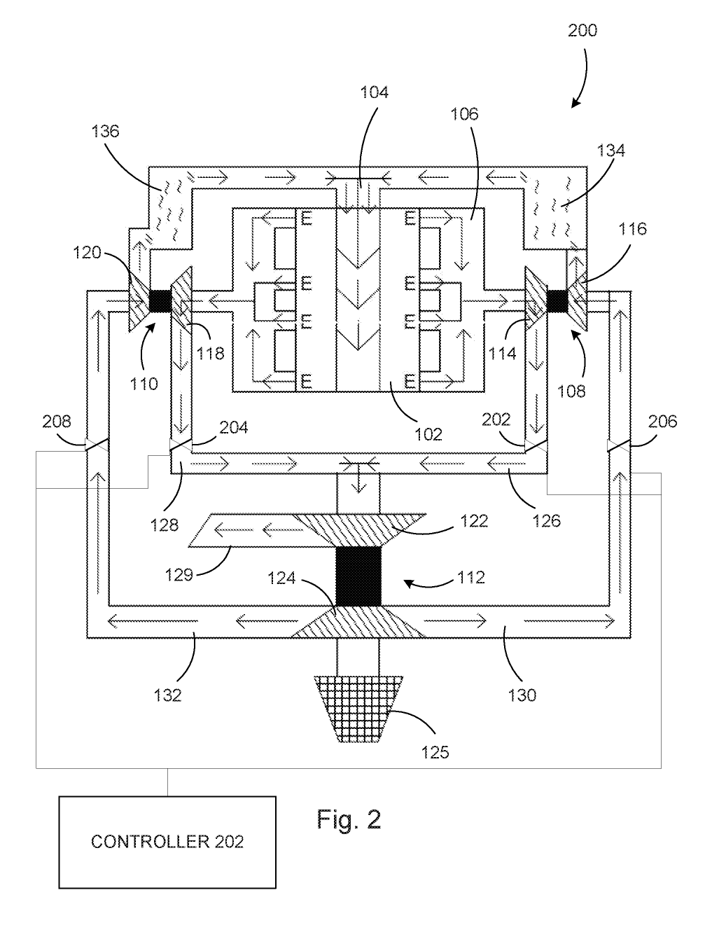

FIG. 2 is a schematic diagram of a multi-turbocharger system 200, according to another embodiment. The turbocharger system 200 is generally similar to the turbocharger system 100 of FIG. 1; however, the turbocharger system 200 also includes first, second, third, and fourth control valves 202, 204, 206, 208 operatively coupled to a controller 210.

The first control valve 202 is positioned in the first exhaust conduit 126 that fluidly couples the first and third turbines 114, 122. The first control valve 202 is controllable between a first position, a second position, and various intermediate positions therebetween. When in the first position, the first control valve 202 enables flow between the first and third turbines 114, 122. When in the second position, the first control valve 202 blocks flow between the first and third turbines 114, 122 and enables flow from the first turbine 114 to external atmosphere. Thus, the first control valve 202 may be referred to as a diverter valve, because it diverts exhaust flow to external atmosphere rather than to the third turbine 122. In some embodiments, the first control valve 202 is a bypass valve that routes the exhaust gas around the third turbine 122 so as to bypass the third turbine 122 to external atmosphere. In some embodiments, the first control valve 202 is internal to the third turbocharger 112. In other embodiments, the first control valve 202 is external to the third turbocharger 112 and is operatively coupled to a bypass passage so as to bypass the exhaust gas around the third turbine 122.

The second control valve 204 is positioned in the second exhaust conduit 128 that fluidly couples the second and third turbines 118, 122. The second control valve 204 is controllable between a first position, a second position, and various intermediate positions therebetween. When in the first position, the second control valve 204 enables flow between the second and third turbines 118, 122. When in the second position, the second control valve 204 blocks flow between the second and third turbines 118, 122 and enables flow from the second turbine 118 to external atmosphere. Thus, the second control valve 204 may also be referred to as a diverter valve, because it diverts exhaust flow to external atmosphere rather than to the third turbine 122. In some embodiments, the second control valve 204 is a bypass valve that routes the exhaust gas around the third turbine 122 so as to bypass the third turbine 122 to external atmosphere. In some embodiments, the second control valve 204 is internal to the third turbocharger 112. In other embodiments, the second control valve 204 is external to the third turbocharger 112 and is operatively coupled to a bypass passage so as to bypass the exhaust gas around the third turbine 122. As will be appreciated, in some embodiments, the first and second control valves 202, 204 are integrated as a single control valve downstream of the point in which the first and second exhaust conduits 126, 128 join each other.

The third control valve 206 is positioned in the first intake conduit 130 that fluidly couples the first and third compressors 116, 124. The third control valve 206 is controllable between a first position, a second position, and various intermediate positions therebetween. When in the first position, the third control valve 206 enables flow between the first and third compressors 116, 124. When in the second position, the third control valve 206 blocks flow between the first and third compressors 116, 124 and enables flow from external atmosphere to the first compressor 116. In some embodiments, the third control valve 206 is a bypass valve that routes the intake air around the first compressor 116 so as to route the intake air directly from the third compressor 124 to the intake manifold 104. In some embodiments, the third control valve 206 is internal to the first turbocharger 108. In other embodiments, the third control valve 206 is external to the first turbocharger 108 and is operatively coupled to a bypass passage so as to bypass the intake air around the first compressor 116.

The fourth control valve 208 is positioned in the second intake conduit 132 that fluidly couples the second and third compressors 120, 124. The fourth control valve 208 is controllable between a first position, a second position, and various intermediate positions therebetween. When in the first position, the fourth control valve 208 enables flow between the second and third compressors 120, 124. When in the second position, the fourth control valve 208 blocks flow between the second and third compressors 120, 124 and enables flow from external atmosphere to the second compressor 120. In some embodiments, the fourth control valve 208 is a bypass valve that routes the intake air around the second compressor 120 so as to route the intake air directly from the third compressor 124 to the intake manifold 104. In some embodiments, the fourth control valve 208 is internal to the second turbocharger 110. In other embodiments, the fourth control valve 208 is external to the second turbocharger 110 and is operatively coupled to a bypass passage so as to bypass the intake air around the second compressor 120.

The controller 210 is operatively coupled to each of the first, second, third, and fourth control valves 202, 204, 206, 208, and to the engine 102. In some embodiments, the controller 210 is an engine control module (“ECM”). In other embodiments, the controller 210 is a dedicated turbocharger controller. The controller 210 is structured to control operation of the turbocharger system 200 based on monitored operating conditions. For example, the controller 210 is structured to monitor operating conditions by interpreting measurement values received from any of the engine, the first, second, and third turbochargers, 108, 110, 112, and other sensors and devices, such as pressure sensors.

In some embodiments, the controller 210 is structured to control (1) the first and second control valves 202, 204; and/or (2) the third and fourth control valves 206, 208 to effectively operate the turbocharger system 200 as either a twin turbocharger system or a triple turbocharger system. For example, when the first, second, third, and fourth control valves 202, 204, 206, 208 are in the first position, the turbocharger system 200 operates as a triple turbocharger system including the first, second, and third turbochargers 108, 110, 112. When the first, second, third, and fourth control valves 202, 204, 206, 208 are in the second position, the turbocharger system 200 operates as a twin turbocharger system including the first and second turbochargers 108, 110.

According to various embodiments, the controller 210 is structured to control the first, second, third and fourth control valves 202, 204, 206, 208 in response to any of engine speed (RPM), pressure in various parts of the turbocharger system 200, engine load, engine temperature, and turbocharger speed of any of the first, second, and third turbochargers 108, 110, 112. For example, in one embodiment, the controller 210 is structured to control at least one of the first, second, third and fourth control valves 202, 204, 206, 208 so as to operate the turbocharger system 200 as a twin turbocharger system in response to the engine speed being less than a threshold speed, and to operate the turbocharger system 200 as a triple turbocharger system in response to the engine speed being greater than the threshold speed.

For example, in one embodiment, the third and fourth control valves 206, 208 are controlled to the second position in response to an engine speed (e.g., RPM) of the engine 102 being below a threshold value. In this configuration, the first and second compressors 116, 120 receive intake air directly from external atmosphere without having been first pre-compressed by the third compressor 124. This reduces the load on the first and second compressors 116, 120, because energy is not being used to bring the third compressor 124 up to speed. In some embodiments, the first and second control valves 202, 204 are also controlled to the second position in response to the engine speed being below the threshold value. In one embodiment, the threshold speed is 5,000 RPM. In another embodiment, the threshold speed is 6,500 RPM. In some embodiments, the threshold speed is a speed at which the first and second turbochargers operate at maximum pressure efficiency. In some embodiments, the third and fourth control valves 206, 208 are controlled between the first and second positions over a range between first and second threshold values. For example, the third and fourth control valves 206, 208 begin to move from the second position to the first position in response to the engine speed exceeding the first threshold value. The third and fourth control valves 206, 208 continue to move from the second position towards the first position as the engine speed increases, reaching the second position in response to the engine speed reaching the second threshold value. This gradually phases in the third turbocharger 112. For example, in one embodiment, the third and fourth control valves 206, 208 are controlled so as to phase in the third turbocharger 112 in response to the engine speed increasing from 5,000 to 6,500 RPM.

The third and fourth control valves 206, 208 are controlled to the first position in response to the engine speed being greater than the threshold value. In this configuration, the third compressor 124 is fluidly coupled to each of the first and second compressors 116, 120 so as to pre-compress the intake air. This produces higher boost by providing dual two-stage compression. In some embodiments, the first and second control valves 202, 204 are also controlled to the second position in response to the engine speed being greater than the threshold value.

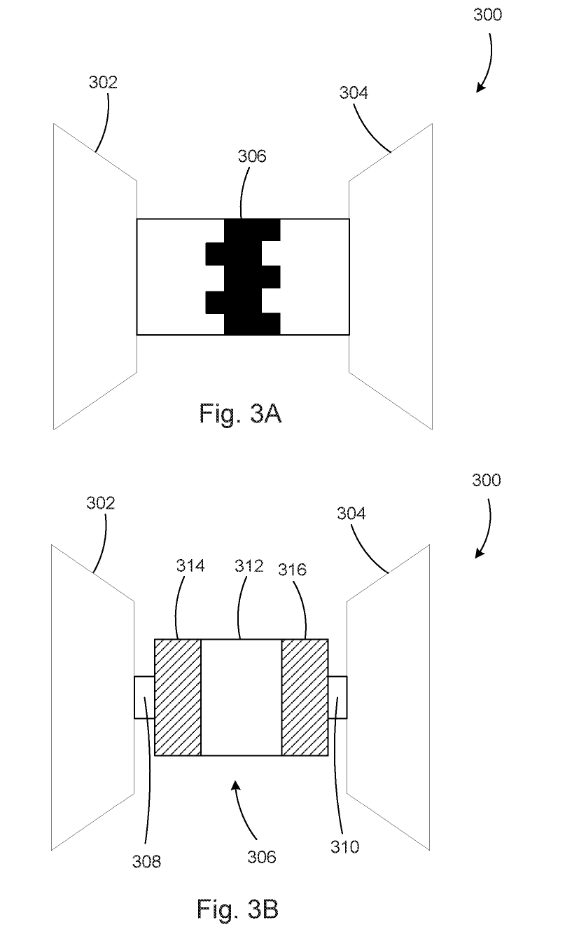

FIG. 3A is a schematic diagram of a variable velocity turbocharger 300, according to an embodiment. In some embodiments, the variable velocity turbocharger 300 is utilized as the third turbocharger 112 of the systems 100, 200 of FIGS. 1 and 2. As will be appreciated, the variable velocity turbocharger 300 is structured to control a turbine and a compressor at different rotational velocities.

The variable velocity turbocharger 300 includes a compressor 302 and a turbine 304. The compressor 302 is structured to be fluidly coupled to an intake manifold of an engine. The turbine 304 is structured to be fluidly coupled to an exhaust manifold of the engine. The variable velocity turbocharger 300 also includes a variable velocity turbocharger differential 306 structured to control a first rotational velocity of the compressor 302 relative to a second rotational velocity of the turbine 304. In some embodiments, impellers of the compressor 302 and the turbine 304, and the variable velocity turbocharger differential 306 are integrated as a center housing rotating assembly (“CHRA”).

The variable velocity turbocharger 300 includes a first shaft (shown in FIG. 3B) operatively coupled to the compressor 302 and to the variable velocity turbocharger differential 306. A second shaft is operatively coupled to the turbine 304 and to the variable velocity turbocharger differential 306. The variable velocity turbocharger differential 306 is structured to controllably transmit torque between the turbine 304 and the compressor 302. In some embodiments, the variable velocity turbocharger differential 306 is a limited slip differential that permits a controlled amount of “slip” between the shafts of the turbine 304 and the compressor 302 so as to controllably permit a different speed of the turbine 304 relative to that of the compressor 302. In some embodiments, the variable velocity turbocharger differential 306 is hydraulically actuated (e.g., via oil). In some embodiments, the variable velocity turbocharger differential 306 includes a clutch pack structured to controllably transmit torque between the turbine 304 and the compressor 302. In some embodiments, the variable velocity turbocharger differential 306 includes a gear set to transmit torque between the compressor 302 and the turbine 304. In some embodiments, the gear set includes spider gears.

FIG. 3B is a schematic diagram of the variable velocity turbocharger 300, according to another embodiment. As shown in FIG. 3B, the variable velocity turbocharger 300 includes a first shaft 308 operatively coupled to the compressor 302 and to the variable velocity turbocharger differential 306. A second shaft 310 is operatively coupled to the turbine 304 and to the variable velocity turbocharger differential 306.

The variable velocity turbocharger differential 306 includes a first clutch pack 314 operatively coupled to the first shaft 308 and a second clutch pack 316 operatively coupled to the second shaft 310. An actuator cartridge 312 is operatively coupled to each of the first and second clutch packs 314, 316. The actuator cartridge 312 is controllably actuated between a first position in which the actuator cartridge 312 is completely collapsed and a second position in which the actuator cartridge 312 is completely expanded, and various intermediate positions therebetween. The actuator cartridge 312 moves between the first and second positions in response to fluid pressure being provided to the actuator cartridge 312. The actuator cartridge 312 moves towards the second position in response to an increase in fluid pressure. This in turn increases the pressure applied to the first and second clutch packs 314, 316, thereby transferring increasingly more torque between the first and second shafts 308, 310. The actuator cartridge 312 can be considered to be “fully disengaged” in the first position so that the compressor 302 is free-spinning relative to the turbine 304. Conversely, the actuator cartridge 312 can be considered to be “fully engaged” in the second position so that the compressor 302 and the turbine 304 rotate synchronously. The actuator cartridge 312 is partially engaged when between the first and second positions so as to enable a controlled amount of torque to be transferred between the compressor 302 and the turbine 304.

In embodiments in which the variable velocity turbocharger 300 is operated as the third turbocharger 112 in the triple turbocharger system 100, 200 of FIGS. 1 and 2, the variable velocity turbocharger differential 306 is controllably actuated to selectively engage the compressor 302. Accordingly, the turbocharger system 100, 200 is effectively controlled as either a twin turbocharger system or a triple turbocharger system. As noted above in connection with FIG. 2, this type of operation can be accomplished by actuating control valves, such as the first, second, third, and/or fourth control valves 202, 204, 206, 208. However, controlling operation of the turbocharger systems 100, 200 via the variable velocity turbocharger differential 306 provides various technical advantages over the turbocharger systems 100, 200. For example, by utilizing the variable velocity turbocharger 300, the first, second, third, and fourth control valves 202, 204, 206, 208 may be eliminated. Cables, plumbing, and other hardware associated therewith may also be eliminated. This reduces cost, weight, and part count of the system. This also simplifies control parameters, as operation of the first and second control valves 202, 204 and/or the third and fourth control valves 206, 208 need not be synchronous.

The variable velocity turbocharger differential 306 may be controlled in a manner generally similar to that described above in connection with the system 200 of FIG. 2. However, instead of operating the first and second and/or third and fourth control valves 202, 204, 206, 208, the variable velocity turbocharger differential 306 is actuated to the first position in response to an engine speed being below a threshold value, and is actuated to the second position in response to the engine speed being above the threshold value. As with the system 200 of FIG. 2, the variable velocity turbocharger differential 306 may be phased in over a range of engine speeds.

The schematic flow chart diagrams and method schematic diagrams described above are generally set forth as logical flow chart diagrams. As such, the depicted order and labeled steps or processes are indicative of representative embodiments. Other steps, processes orderings and methods may be conceived that are equivalent in function, logic, or effect to one or more steps, or portions thereof, of the methods illustrated in the schematic diagrams. Further, reference throughout this specification to “one embodiment,” “an embodiment,” “an example embodiment,” or similar language means that a particular feature, structure, or characteristic described in connection with the embodiment is included in at least one embodiment of the present invention. Thus, appearances of the phrases “in one embodiment,” “in an embodiment,” “in an example embodiment,” and similar language throughout this specification may, but do not necessarily, all refer to the same embodiment.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Many of the functional units described in this specification have been labeled as circuits in order to more particularly emphasize their implementation independence. For example, a circuit may be implemented as a hardware circuit comprising custom very-large-scale integration (VLSI) circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

As mentioned above, circuits may also be implemented in machine-readable medium for execution by various types of processors. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

The computer readable medium (also referred to herein as machine-readable media or machine-readable content) may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. As alluded to above, examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain and/or store computer readable program code for use by and/or in connection with an instruction execution system, apparatus, or device.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

1. A system, comprising:
a first turbocharger comprising a first turbine in fluid receiving communication with an exhaust manifold of an engine, and a first compressor in fluid providing communication with an intake manifold of the engine;
a second turbocharger comprising a second turbine in fluid receiving communication with the exhaust manifold, and a second compressor in fluid providing communication with the intake manifold;
a third turbocharger comprising a third turbine in fluid receiving communication with each of the first and second turbines, and a third compressor in fluid providing communication with each of the first and second compressors;
a first control valve positioned in a first intake conduit fluidly coupling the first and third compressors, the first control valve controllable between a first position permitting flow between the first and third compressors, and a second position blocking flow between the first and third compressors and permitting flow from external atmosphere to the first compressor; and
a second control valve positioned in a second intake conduit fluidly coupling the second and third compressors, the second control valve controllable between a first position permitting flow between the second and third compressors, and a second position blocking flow between the second and third compressors and permitting flow from external atmosphere to the second compressor.

2. The system of claim 1, further comprising a controller operatively coupled to each of the first and second control valves, the controller structured to actuate each of the first and second control valves between the first and second positions.

3. The system of claim 2, wherein the system effectively operates as a triple turbocharger system when the first and second control valves are in the first position, and as a twin turbocharger system when the first and second control valves are in the second position.

4. The system of claim 2, wherein the controller is further operatively coupled to the engine, the controller further structured to:
actuate each of the first and second control valves to the second position in response to a rotational speed of the engine being below a threshold value; and
actuate each of the first and second control valves to the first position in response to the rotational speed of the engine being above the threshold value.

5. The system of claim 2, wherein the controller is further operatively coupled to the engine, the controller further structured to actuate each of the first and second control valves from the second position to the first position in response to a rotational speed of the engine traversing a range extending between a first threshold value and a second threshold value.

6. The system of claim 1, further comprising:
a third control valve positioned in a first exhaust conduit fluidly coupling the first and third turbines, the first control valve controllable between a first position enabling flow between the first and third turbines, and a second position blocking flow between the first and third turbines and enabling flow from the first turbine to external atmosphere; and
a fourth control valve positioned in a second exhaust conduit fluidly coupling the second and third turbines, the second control valve controllable between a first position enabling flow between the second and third turbines, and a second position blocking flow between the second and third turbines and enabling flow from the second turbine to external atmosphere.

7-15. (canceled)
